(19) United States
(12) Patent Application Publication
(10) Pub. No.: US 2012/0098427 A1
(43) Pub. Date: Apr. 26, 2012

(54) DISCHARGE LAMP LIGHTING APPARATUS AND MANUFACTURING METHOD THEREOF

(75) Inventors: Kaname Miyagishima, Shizuoka (JP); Hiroki Ishibashi, Shizuoka (JP)

(73) Assignee: Koito Manufacturing Co., Ltd., Tokyo (JP)

(21) Appl. No.: 13/275,427

(22) Filed: Oct. 18, 2011

(30) Foreign Application Priority Data
Oct. 22, 2010 (JP) 2010-237362

(51) Int. Cl. H01J 61/56; H01J 9/36

(52) U.S. Cl. 315/51; 445/26

(57) ABSTRACT

A discharge lamp lighting apparatus includes a housing that is formed by a box-shaped housing main body, which has therein a first circuit including both a first connection connector that protrudes toward an opening and a first electronic part group, and a discharge lamp bulb attached to the outside of the housing main body. A housing cover has a heat dissipating metal body on a back surface of a substrate having mounted thereon both a second connection connector that protrudes at a position corresponding to the first connection connector and a second electronic part group having lower heat resistance than the first electronic part group, and that is attached to the opening. The second connection connector is mounted to the first connector when the housing cover is attached to the housing main body.

### TECHNICAL FIELD

The present disclosure relates to discharge lamp lighting apparatuses that are easy to manufacture and that have high reliability, and to manufacturing methods of the discharge lamp lighting apparatus.

### BACKGROUND

Japanese Patent Application Laid-Open (Kokai) No. 2008-305641 describes a lighting apparatus of a discharge lamp bulb that serves as a light source of a vehicular lamp. The disclosed discharge lamp lighting apparatus of is an apparatus in which a discharge lamp (bulb) is attached via a socket to a case body containing a lighting circuit portion. The lighting circuit portion is configured by mounting small electronic parts such as a switching element, a coil, a ceramic capacitor, a chip resistor, and an integrator on a surface mounting substrate placed on a bottom portion of the case body, and also connecting large electronic parts such as an electrolytic capacitor, a transformer, and a coil to the surface mounting substrate via a bus bar.

In the discharge lamp lighting apparatus of JP 2008-305641, the discharge lamp and the group of large electronic parts are connected to the surface mounting substrate via the bus bar. Terminals of the discharge lamp, the group of large electronic parts and the like typically are connected to the bus bar, for example, by laser welding. In the discharge lamp lighting apparatus of JP 2008-305641, however, the inside of the case body is closed by the discharge lamp and the bottom portion, and it is difficult to irradiate the terminals and the bus bar located inside the closed case body with light from the outside. This situation makes it difficult to manufacture the discharge lamp lighting apparatus.

Moreover, in the discharge lamp lighting apparatus of JP 2008-305641, the surface mounting substrate is provided horizontally below a base end of the socket in order to prevent further heating of high heat-generating parts (such as the switching element) by the discharge lamp. Thus, in the discharge lamp lighting apparatus of JP 2008-305641, the case body significantly protrudes downward as a trade-off to ensure reliability of the surface mounting substrate, which hinders reduction in size of vehicular lamps having the discharge lamp lighting apparatus.

In view of the foregoing problems, the present disclosure describes a discharge lamp lighting apparatus that is easy to manufacture and that allows reduction in size to be implemented while ensuring reliability. A manufacturing method for the discharge lamp lighting apparatus also is described.

### MEANS FOR SOLVING THE PROBLEM

In order to address the foregoing problems, a discharge lamp lighting apparatus according to one aspect includes a discharge lamp bulb; a housing having a box-shaped housing main body that has an opening in a part thereof, and that is configured so as to allow the discharge lamp bulb to be mounted outside the housing main body. The apparatus further includes a first circuit that, together with at least a part of an electrode for supplying electric power to the discharge lamp bulb, is accommodated inside the housing main body, and that has a first electronic part group mounted thereon. A housing cover has a second circuit including a mounting substrate having mounted thereon a second electronic part group that has lower heat resistance than the first electronic part group. A metal body has, in at least a part thereof, a planar portion, which is fixed to a back surface of the mounting substrate so as to be in surface contact with the back surface of the mounting substrate, and that is attached to the housing main body so as to close the opening. The first circuit has a first connection connector that is electrically connected to the electrode, and that protrudes toward the housing cover. The second circuit has a second connection connector that protrudes at a position such that the second connection connector is mounted to the first connector by attaching the housing cover to the housing main body.

(Operation) The second connection connector in the second circuit can be mounted to the first connection connector of the first circuit by attaching the housing cover to the housing main body. Thus, electrical connection between the first circuit and the second circuit is made automatically by attaching the housing cover to the housing main body.

Moreover, heat that is generated in the second circuit or to which the second circuit is subjected is dissipated to the outside of the housing main body via the plate-shaped metal body that is in surface contact with the back surface of the mounting substrate via the planar portion. As a result, the second electronic part group, which is mounted on the second circuit and is not so resistant to heat, is less susceptible to heat even if the second electronic part group is subjected to heat from the discharge lamp bulb or the like by placing the second circuit behind a base end of the discharge lamp bulb so that the second circuit faces the base end of the discharge lamp bulb. Thus, in some implementations, the discharge lamp lighting apparatus allows the second circuit to be placed behind the base end of the discharge lamp body without impairing reliability against heat.

In some implementations, the first circuit is formed by a metal bus bar to which the first electronic part group and the electrode are electrically connected by welding, and a resin that covers a part of the metal bus bar. The first connection connector is formed integrally with the first circuit by a connector terminal portion molded integrally with a part of the metal bus bar, and a connector housing molded integrally with the resin that covers the bus bar.

(Operation) As the terminal of the first connector is formed as a part of the metal bus bar, and the connector housing is formed as a part of the housing main body made of a resin, the first connector is formed integrally with the housing main body when the housing main body is integrally molded from the metal bus bar and the resin.

In some implementations, the electrode includes a first electrode to which a high voltage is applied and a second electrode to which the high voltage is not applied. An insulating cover covers the first electrode, and a portion of the first circuit which is connected to the first electrode is attached to the housing main body. The mounting substrate is an insulating substrate.

(Operation) As the insulating cover electrically shields the first circuit from the second circuit, and the mounting substrate has an insulating property, a shielding property between the first circuit and the plate-shaped metal body is improved. This, feature helps prevent a discharge phenomenon that occurs between the first circuit and the second circuit and between the first circuit and the plate-shaped metal body.

According to another aspect, the discharge lamp lighting apparatus can be manufactured by a method that includes forming a housing having a discharge lamp bulb attached thereto by forming a box-shaped housing main body that has an opening in a part thereof, and integrally forming a first circuit inside the housing main body, forming on the first circuit a first connection connector that protrudes in a direction in which the opening opens, mounting a first electronic part group on the first circuit, and attaching the discharge lamp bulb to outside of the housing main body and electrically connecting an electrode of the discharge lamp bulb to the first circuit inside the housing main body by welding of. The method also includes forming a housing cover by a step of forming a second circuit by mounting on a mounting substrate a second electronic part group having lower heat resistance than the first electronic part group, fixing a planar portion of a metal body, which is provided in at least a part of the metal body, to a back surface of the mounting substrate so as to be in surface contact with the back surface of the mounting substrate, and providing a second connection connector so as to protrude at a position corresponding to the first connector on the second circuit; and mounting the second connector to the first connector by attaching the housing cover to an opening edge portion of the housing main body.

(Operation) The discharge lighting apparatus can be manufactured by manufacturing the housing and manufacturing the housing cover. The housing can be manufactured by first forming inside the housing main body the first circuit having both the first connection connector and the first electronic part group mounted thereon, and then attaching the discharge lamp bulb to the outside of the housing main body. The housing cover can be manufactured by forming the second circuit by mounting on the mounting substrate the second connection connector capable of being mounted to the first connection connector and the second electronic part group that is less resistant to heat than the first electronic part group, and fixing the metal body to the back surface of the metal body via the planar portion. The second connector then can be mounted to the first connector by attaching the housing cover to the housing. In some implementations, the second connection connector is automatically mounted to the first connection connector by attaching the housing cover to the housing having the bulb attached thereto, whereby the second circuit is electrically connected to the first circuit.

As the electrical connection between the first circuit and the second circuit can be made by mounting the second connection connector to the first connection connector, a welding operation or the like is not required, thereby facilitating manufacturing of the discharge lamp lighting apparatus.

Moreover, the second circuit can be placed behind the base end of the discharge lamp bulb without impairing the reliability of the second circuit against heat generation. Thus, the housing main body can be formed with a small size without protruding downward, whereby the size of the discharge lamp lighting apparatus can be reduced.

In some cases, the first connector can be easily formed on the first circuit as compared to the case where the first connector is formed as a separate member and is connected to the first circuit, thereby facilitating manufacturing of the apparatus.

In some implementations, the discharge phenomenon in the housing main body is prevented, and an insulating property is improved, whereby reliability of the apparatus is further improved.

In some implementations, the electrical connection between the first circuit and the second circuit can be made by mounting the second connection connector to the first connection connector, whereby the discharge lamp lighting apparatus can be manufactured easily.

### BRIEF DESCRIPTION OF THE DRAWINGS

FIG. 1 is a schematic longitudinal cross-sectional view of a vehicular lamp having a discharge lamp lighting apparatus.

FIG. 2 is a partial cross-sectional view of a housing and shows the inside of a housing main body.

FIG. 3 is a perspective view illustrating a configuration of a bus bar and a first circuit.

FIG. 4 is an exploded perspective view of the discharge lamp lighting apparatus.

### DETAILED DESCRIPTION

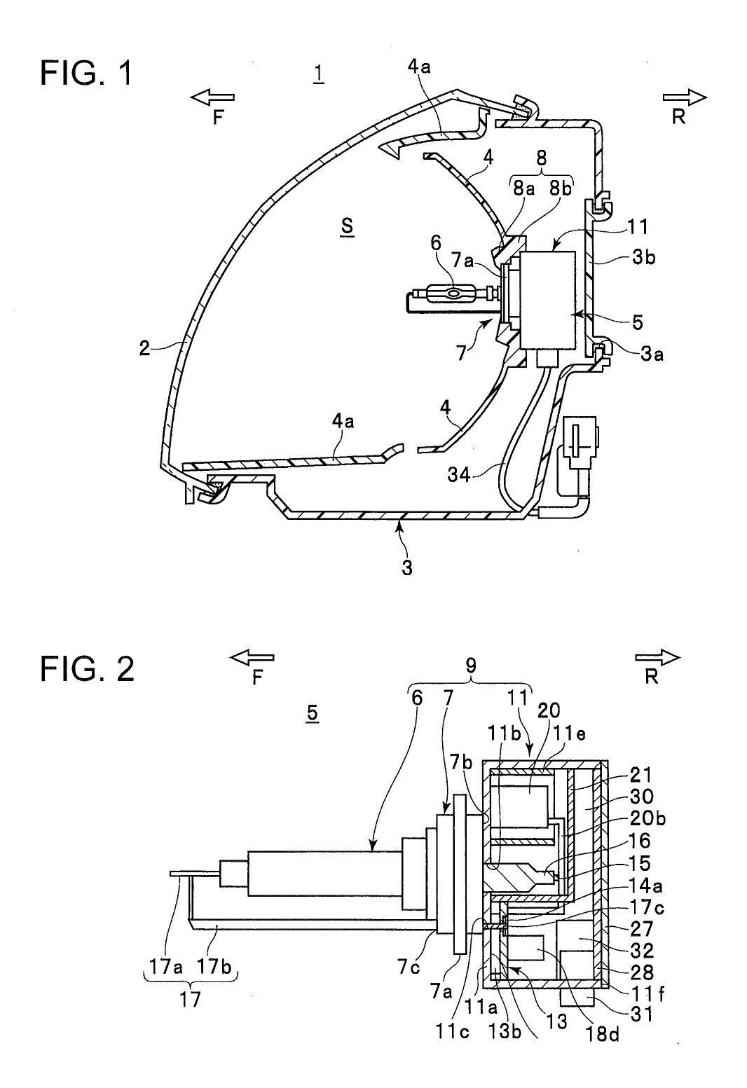

An example of a discharge lamp lighting apparatus according to the present invention is described with reference to FIGS. 1 to 4.

FIG. 1 shows a vehicular lamp including a discharge lamp lighting apparatus of the embodiment. In the description of FIGS. 1 and 2, a left direction F represents a forward direction of the vehicle, and a right direction R represents a rearward direction of the vehicle. The vehicular lamp 1 of FIG. 1 has a front cover 2 made of a transparent material such as a resin, a lamp body 3 made of a resin, a back cover 3b that closes an opening 3a of the lamp body, a reflector 4 that reflects light of a discharge lamp bulb 6 in the forward direction, an extension reflector 4a that partially blocks the inside of a lamp chamber S from the front, and a discharge lamp lighting apparatus 5 having the discharge lamp bulb 6 integrated therewith. The front cover 2 is integrated with the lamp body 3. The lamp chamber S is defined inside the lamp body 3, and the reflector 4 is fixed inside the lamp body 3. A supporting portion 8 that fixes the discharge lamp lighting apparatus 5 to the reflector 4 is provided in the center of the reflector 4. The supporting portion 8 that opens in the forward and rearward directions is formed by a first supporting portion 8a in a stepped configuration that supports a flange portion 7a of a socket 7 to which the discharge lamp bulb 6 (described below) is connected, and a second supporting portion 8b that supports a housing main body 11 of the discharge lamp lighting apparatus 5.

The discharge lamp lighting apparatus 5 is formed by a housing 9 having the bulb integrated therewith, and a housing cover 25, as shown in FIG. 2. The housing 9 is formed by the discharge lamp bulb 6, the socket 7, the housing main body 11 made of a resin and having a box shape, and a first circuit 13, which functions as a start circuit of the discharge lamp bulb. The housing cover 25 is formed by a metal body 27 a second circuit 26, which functions as a lighting circuit of the discharge lamp bulb 6.

A base end of the discharge lamp bulb 6 is connected to a front end of the socket 7, and the flange portion 7a described above is provided on the outer periphery of the socket 7. A cylindrical base end 16 having a high voltage-side electrode 15 is provided on a rear end face 7b of the socket 7 so as to protrude in the rearward direction. A low voltage-side electrode 17, which is formed by an electrode 17a protruding in the forward direction and an electrode 17b extending downward from the electrode 17a and being bent in the rearward direction, is provided on a tip end of the discharge lamp bulb 6. A base end 17c of the electrode 17b extends through an insertion hole 7c of the socket 7 and protrudes in the rearward direction beyond the rear end face 7b.

In the illustrated embodiment, the discharge lamp bulb 6 is integrated with the socket 7 in a non-detachable manner. However, the discharge lamp bulb 6 may be configured so that it can be attached to and detached from the socket 7. In this case, for example, the discharge lamp bulb 6 and the socket 7 are configured so that electrodes corresponding to the high voltage-side electrode 15 and the low voltage-side electrode 17 are provided on the side of the socket 7, and that the discharge lamp bulb 6 is electrically connected to the socket 7 by mounting the discharge lamp bulb 6 on the socket 7.

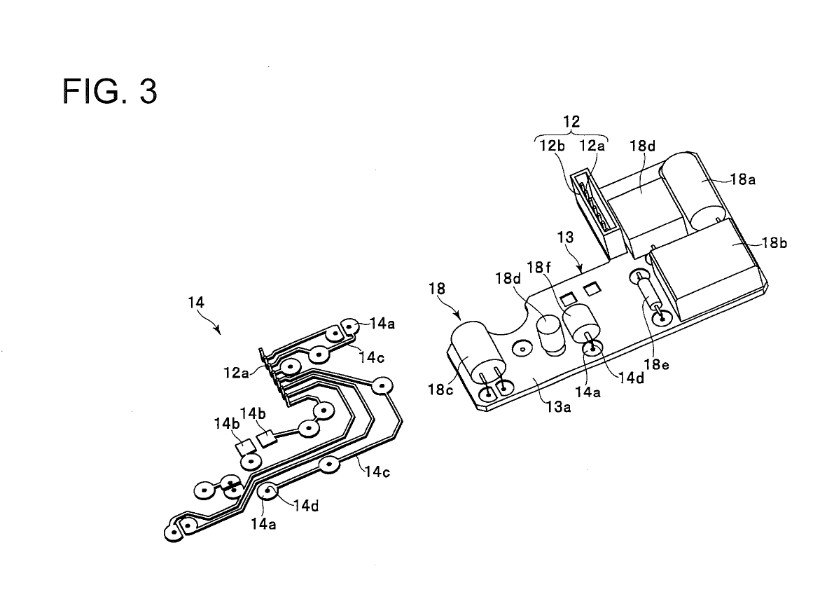

The first circuit 13 shown in the right drawing of FIG. 3 is formed by integrally molding a metal bus bar 14 (shown in the left drawing of FIG. 3) in a resin and mounting a first electronic part group 18. The metal bus bar 14 is formed in a desired shape by cutting out a sheet metal. The metal bus bar 14 is formed by a plurality of disc-shaped terminals 14a, rectangular terminals 14b for attaching a starter transformer, bar-shaped conductive wire portions 14c connecting the terminals, and terminals 12a each formed by bending a terminal end of the conductive wire portion 14c perpendicularly to a plane direction of the first circuit 13. The bus bar 14 is integrally molded inside a plate-shaped resin 13a so that the terminals (14a, 14b) are exposed.

The first circuit 13 has a first connection connector 12 in a male configuration. The first connection connector 12 is formed in the male configuration by the terminals 12a and a rectangular connector housing 12b that is made of a resin and that is formed integrally with the plate-shaped resin 13a so as to surround the terminals 12a. The first electronic part group 18 is formed by capacitors (18a to 18c), coils 18d, a resistive element 18e, a spark cap 18f, a starter transformer 20, and the like. The first electronic part group 18 is electrically connected to the bus bar 14 by laser-welding lead portions of the first electronic part group 18 to the terminals 14a. The lead portions are fixed to the terminals 14a by inserting the lead portions into holes 14d of the terminals 14a and subjecting the lead portions to heat of laser light with the lead portions in contact with inner peripheral surfaces of the holes 14d. The lead portions of the electronic part group can be connected to the terminals of the bus bar by resistance welding. In the resistance welding, the leads are welded to the terminals of the bus bar by sandwiching the leads and the terminals of the bus bar by metal electrodes respectively placed at upper and lower positions, to bring the leads into contact with the terminals of the bus bar, and in this state, applying a large current to the upper and lower electrodes to generate heat from the leads and the bus bar.

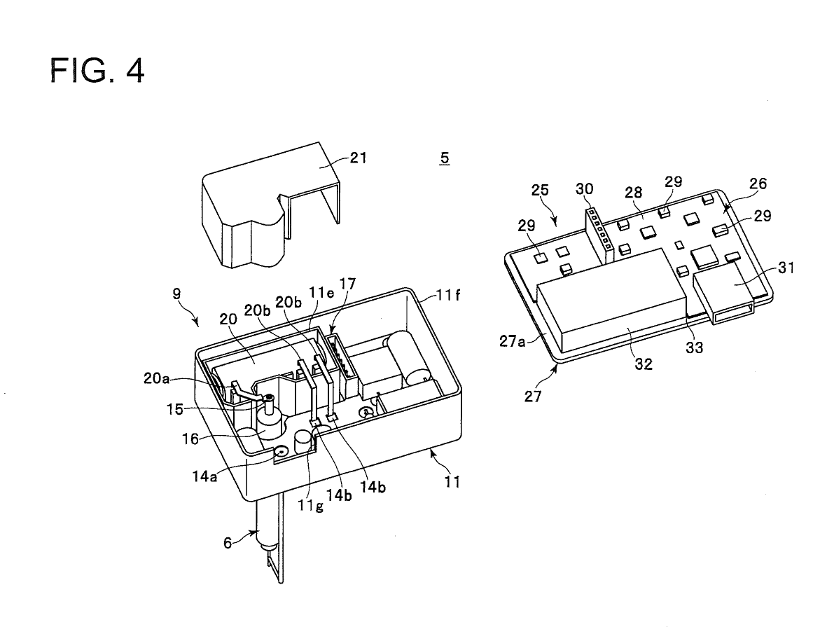

The resin housing main body 11 has a box shape having an opening edge portion 11f in the rear as shown in FIG. 4, and the formed circuit 13 is attached by, for example, bonding a leg portion 13b to an inner bottom 11d of the resin housing main body 11 as shown in FIG. 2. An accommodating portion 11e having a shape of a standing wall and accommodating the starter transformer 20 therein is provided on the inner bottom 11d of the housing main body 11, and the circuit 13 is attached to a portion of the inner bottom 11d other than the accommodating portion 11e. The circuit 13 can be formed by molding the plate-shaped resin 13a that covers the bus bar 14, integrally with the resin housing 11. The first connector 12 can be mounted as a separate member on the circuit 13.

As shown in FIGS. 2 and 4, the socket 7 is fixed to the housing main body 11, for example, by bonding the rear end face 7b to a front end face 11a of the housing main body 11 with the base end 16 inserted through a circular through hole 11b provided in the front end face 11a, and with the base end 17c of the electrode 17b inserted through a circular through hole 11c of the front end face 11a. On the other hand, the starter transformer 20 has a high voltage-side terminal 20a and a plurality of low voltage-side terminals 20b, and is fixed inside the accommodating portion 11e. The high voltage-side terminal 20a of the starter transformer 20 is connected to the high voltage-side electrode 15 of the socket 7 by laser welding, the plurality of low voltage-side terminals 20b are respectively connected to the terminals 14b of the bus bar 14 by laser welding, and the base end 17c of the electrode 17b is connected to the terminal 14a by laser welding. The accommodating portion 11e accommodating the starter transformer 20, the high voltage-side terminal 20a, and the base end 16 of the socket 7 including the high voltage-side electrode 15 are covered by an insulating cover 21 made of a resin or the like, and having an insulating property. The insulating cover 21 is provided on the side of the housing 11 with respect to the metal body 27 of the housing cover 25 (described below) to block a portion receiving a high voltage, thereby preventing a discharge phenomenon that occurs between the high voltage receiving portion and the metal body 27.

On the other hand, the housing cover 25 (shown in the right drawing of FIG. 4) is formed by the second circuit 26 and the metal body 27. The second circuit 26 is formed by a mounting substrate 28 (hereinafter referred to as the “insulating substrate 28”) made of a material having an insulating property such as ceramic or alumina, a second electronic part group 29, a second connection connector 30 in a female configuration and a power supply connector 31, and a transformer 32. The second electronic part group 32 is a plurality of electronic parts having low heat resistance, and these electronic parts are surface-mounted on the insulating substrate 28, and are connected by a metal pattern (not shown) having a conductive property. The second connection connector 30 and the power supply connector 31 are attached to the insulating substrate 28 by bonding or the like, and are joined to the metal pattern via a connection terminal (not shown). As shown in FIG. 1, a power cable 34 with a connector is connected to the power supply connector 31. A front surface 27a (which may be referred to as a “planar portion”) of the metal body 27 is integrated with a back surface of the insulating substrate 28 by bonding or the like. The insulating substrate 28 has a cutout portion 33 that is cut out along the outer shape of the transformer 32 in one corner of the rectangular shape. The transformer 32 is placed in the cutout portion 33 so as to be directly placed on the metal body 27, and is joined to the metal pattern on the insulating substrate 28 via a terminal (not shown).

The second connection connector 30 is attached to the insulating substrate 28 at a position such that the second connection connector 30 faces the first connection connector 12 when the housing cover 25 is attached to the opening edge portion 11f of the housing 9. The second connection connector 30 is formed in the female configuration so as to correspond to the first connection connector 12 in the male configuration so that the second connection connector 30 can be mounted to the first connection connector 12.

The housing cover 25 shown in the right diagram of FIG. 4 is attached to the opening edge portion 11f of the housing 9 with a front surface (a surface on which the second connection connector 30 is mounted) of the insulating substrate 28 facing downward. The housing cover 25 is attached to the housing 9 by a lance structure provided between the housing cover 25 and the housing 9, by bonding the metal body 27 to the opening edge portion 11f or the like. When attaching the housing cover 25 to the housing 9, the power supply connector 31 engages with an engagement cutout 11g provided in the outer peripheral edge portion 11f of the housing main body 11, and the second connection connector 30 is fitted into the first connection connector 12, and thus is mounted to the first connection connector 12.

The first circuit 13 is electrically connected to the second circuit 26 via the first and second connection connectors (12, 30), and receives power supply from the power supply connector 31. As the high voltage portion placed in the first circuit 13 is shielded from the metal body 27 by the insulating cover 21 and the insulating substrate 28, no discharge phenomenon occurs between the first circuit 13 and the second circuit 26 and between the first circuit 13 and the metal body 27. On the other hand, as heat received by the second circuit 26 from the base end of the discharge lamp bulb 6, etc. and heat generated in the second circuit 26 are dissipated to the outside of the housing main body 11 via the metal body 27, the second electronic part group 29 having low heat resistance is less susceptible to heat.

As an example, the housing main body 11 can be molded by a resin, which is preferable because of its high moldability and high insulating property. However, the housing main body 11 can be molded by a metal. In that case, however, an insulating property needs to be ensured, for example, by placing a member having an insulating property between a first electrode and a second electrode. Advantages such as high heat resistance and a high heat dissipation property can be obtained in the case where the housing main body is formed of a metal.

The housing main body 11 of the illustrated implementation is formed in a box shape having an opening in a part of the box as an example, because the housing main body 11 is shaped so as to be able to accommodate the first electrode, the second electrode, the first circuit, and the like. Thus, the housing main body can be formed in various shapes having an opening in a part thereof, such as common shapes like a rectangular parallelepiped, a cylinder, shapes extending in a tube shape with an elliptical or polygonal bottom surface, and the like, so long as the housing main body is able to accommodate the first electrode, the second electrode, the first circuit, and the like.

Other implementations are within the scope of the claims.

What is claimed is:

1. A discharge lamp lighting apparatus including:
a discharge lamp bulb;
a housing having a box-shaped housing main body that has an opening in a part thereof, and that is configured so as to allow the discharge lamp bulb to be mounted outside the housing main body, and a first circuit that, together with at least a part of an electrode for supplying electric power to the discharge lamp bulb, is accommodated inside the housing main body, and that has a first electronic part group mounted thereon; and
a housing cover that has a second circuit including a mounting substrate having mounted thereon a second electronic part group having lower heat resistance than the first electronic part group, and a metal body having in at least a part thereof a planar portion, which is fixed to a back surface of the mounting substrate so as to be in surface contact with the back surface of the mounting substrate, and that is attached to the housing main body so as to close the opening, wherein
the first circuit has a first connection connector that is electrically connected to the electrode, and that protrudes toward the housing cover, and
the second circuit has a second connection connector that protrudes at a position such that the second connection connector is mounted to the first connector by attaching the housing cover to the housing main body.

2. The discharge lamp lighting apparatus according to claim 1, wherein
the first circuit comprises a metal bus bar to which the first electronic part group and the electrode are electrically connected by welding, and a resin that covers a part of the metal bus bar, and
the first connection connector is formed integrally with the first circuit by a connector terminal portion molded integrally with a part of the metal bus bar, and a connector housing molded integrally with the resin that covers the bus bar.

3. The discharge lamp lighting apparatus according to claim 1, wherein the electrode includes a first electrode to which a high voltage is applied and a second electrode to which the high voltage is not applied, and an insulating cover that covers the first electrode and a portion of the first circuit which is connected to the first electrode is attached to the housing main body, and wherein the mounting substrate is an insulating substrate.

4. The discharge lamp lighting apparatus according to claim 2, wherein the electrode includes a first electrode to which a high voltage is applied and a second electrode to which the high voltage is not applied, and an insulating cover that covers the first electrode and a portion of the first circuit which is connected to the first electrode is attached to the housing main body, and wherein the mounting substrate is an insulating substrate.

5. A method for manufacturing a discharge lamp lighting apparatus, the method comprising:
a first step group of forming a housing having a discharge lamp bulb attached thereto, by a step of forming a box-shaped housing main body that has an opening in a part thereof, and integrally forming a first circuit inside the housing main body, a step of forming on the first circuit a first connection connector that protrudes in a direction in which the opening opens, a step of mounting a first electronic part group on the first circuit, and a step of attaching the discharge lamp bulb to outside of the housing main body and electrically connecting an electrode of the discharge lamp bulb to the first circuit inside the housing main body;
a second step group of forming a housing cover by a step of forming a second circuit by mounting on a mounting substrate a second electronic part group having lower heat resistance than the first electronic part group, a step of fixing a planar portion of a metal body, which is provided in at least a part of the metal body, to a back surface of the mounting substrate so as to be in surface contact with the back surface of the mounting substrate, and a step of providing a second connection connector so as to protrude at a position corresponding to the first connector on the second circuit; and
a third step of mounting the second connector to the first connector by attaching the housing cover to an opening edge portion of the housing main body.
